(19) United States
(12) Patent Application Publication
(10) Pub. No.: US 2012/0077908 A1
(43) Pub. Date: Mar. 29, 2012

(54) Method for the Production of Wood Material Articles with Low Emissions of Chemical Compounds

(76) Inventors: Wolfgang Seifert, Dresden (DE); Erhard Prantz, Krems (AT)

(21) Appl. No.: 13/312,469

(22) Filed: Dec. 6, 2011

Related U.S. Application Data
(63) Continuation of application No. 11/989,415, filed on May 9, 2008, now abandoned.

(51) Int. Cl. C08L 97/02

(52) U.S. Cl. 524/13

(57) ABSTRACT

The invention relates to a method for production of wood material articles with low emissions of chemical compounds. The applied wood is treated with bisulfite before bonding. On using formaldehyde resins in the bonding agent, wood material articles can be produced with the inventive method with extremely low formaldehyde emissions and very bright colours.

### CROSS-REFERENCE TO RELATED APPLICATIONS

The present application is a continuation of U.S. Non-Provisional application Ser. No. 11/989,415 filed May 9, 2008, still pending, which is the National Stage of International Application No. PCT/EP2005/053674, filed Jul. 27, 2005.

### BACKGROUND OF THE INVENTION

The invention relates to a method for the production of a wood material article with a low emission of chemical compounds as well as a wood material article, which can be obtained by this method.

Wood material articles, as for example, chip boards or fibre boards, are produced of wood chips of fibre materials in combination with glue. Usually, the glue is applied during the manufacturing of the wood material article onto the hackled wood (chips) or the fibre material and after that the resulting, still moist wood material articles are pressed with high temperatures (hot pressing), whereby the glue is cured respectively hardened. For a long time, the formaldehyde containing resins are used in such glues as curing agents and/or binding agents.

Wood material boards are often used inside of closed rooms. Therefore it is important, that the chipboards do not emit disturbing (like, for example, components with a strong smell) or even harmful components. The emitted components can derive from the wood itself or also from the applied glue.

When using formaldehyde containing resins for the manufacturing of wood material articles, the resulting articles emit amounts of formaldehyde, whereby the amount is limited due to legal regulations and voluntarily restrictions of the industry to extremely low thresholds.

Different methods are known to reduce the formaldehyde content and in particular the emission of formaldehyde from the resulting wood material articles. Some of them are:

1. Modification of the glue by reducing the molar relationship of formaldehyde to the other components of the resin;

2. Adding of substances which bind formaldehyde, as for example carbamide;

3. Mixing of resins containing formaldehyde with other resins; or

4. Increasing the pressing time.

These methods, however, lower the efficiency of the production process (increased costs, lower production capacity by increased production time, etc.) or they have negative physical or mechanical effects to the product (reduction of the resin stability, reduction of the stability and the resistance of the glue seams etc.)

It is therefore one object of the present invention to provide an improved method for the production of wood material articles, whereby the resulting wood material articles show in particular a lower emission of chemical compounds.

This object is solved by a method for the production of a wood material article comprising wood chips or wood fibres which are glued together, wherein the wood is treated with bisulfite before the gluing process.

Surprisingly it has been found, that by means of the inventive method, improved wood material articles can be produced, which in particular show only low or no undesired emissions of (volatile) chemical compounds which originate from the wood itself. Further, the wood chips or wood fibres treated with bisulfite show an improved reaction with the glue.

Further preferred embodiments of the method are subject to the sub claims.

For the production of wood material articles, usually wood of broad leaved trees or needle leaved trees are treated either separately or in a mixture. First, the woods are barked and hackled. Hackle chips or wood chips can be added to the hackled wood. After that, this mixture is screened and separated, whereby undesired articles like for example sand, splinters, stones or metals are removed. After that, the mixture is washed, whereby again undesired materials like for example sand or stones are removed. In the next step the hackled wood is heated and dehydrated. This is done preferably by pressing.

The hackled and treated wood is then treated at a pressure of 0.8-12 bar in saturated water steam atmosphere. According to the invention additionally an aquarious solution of bisulfite salt is introduced into the steam atmosphere. The bisulfite salts may for example be alkali and/or ammonium salts. Preferably sodium salts and/or ammonium bisulfite salts are used. Ammonia salt is particularly preferred. The amount of bisulfite salt is in the range of 3 to 30 kg, preferably between 3 and 12 kg per cubic meter of produced board. The duration of the treatment is at least 1.5 minutes and preferably between 3 and 8 minutes. In this case large amounts of bisulfite necessitate longer treatment duration to complete the reaction, to enable the bisulfite to permeate into the fibres and to secure a stable impregnation.

According to the invention, in one embodiment the wood is treated with bisulfite before the production of the wood chips or wood fibres, for example in the cooker, to simplify the implementation of the method. A subsequent impregnation of the wood fibres with paraphine does therefore not negatively influence the effect of the method according to the invention.

According to a further embodiment, the wood chips or wood fibres are treated with a bisulfite, for example in a refiner. In this way, the method can be achieved in a particularly efficient manner.

Without being bound to this theory, the treatment of the hackled wood with the bisulfite is important to bind the volatile substances in the hackled wood and to restrain the regeneration of volatile substances. During the treatment with bisulfite, for example the bisulfite-adducts of aldehydes, methylketone or alpha-ketoester may be formed. Additionally, the bisulfite may evolve its bleaching effect and it may react with the pigments present in the wood, so that particularly bright wood material articles can be achieved. The brightness of a board is an important quality criterion.

Additionally, when treating the wood with bisulfite a slightly acidic impregnation of the fibres occurs, so that in the case of application of formaldehyde containing resins in the glue a complete polycondensation with the resin and thus a complete consumption of the free formaldehyde is achieved. Both effects lead to wood material articles, which show extreme low perforation values and therefore an extremely low emission of formaldehyde.

With a treatment duration with bisulfite of at least 1.5 minutes, it is secured, that the disintegration of the wood is almost complete and the subsequently following treatment with the impregnation agent against an expansion due to moisture is not ineffective.

After that the impregnated wood pieces are further hackled to wood chips or wood fibres, glued, dried and pressed. This is done by common methods.

The glue, which is used for the gluing of the wood chips or wood fibres, is preferably an aninoplast resin. It is particularly preferred, that a formaldehyde containing resin is used. This is preferably chosen from the group consisting of urea formaldehyde resin, melanin-formaldehyde resin, urea melanin-formaldehyde resin and melamine urea-phenol-formaldehyde resin. Suitable resins are commercially available as solutions or as powder and the production and application of suitable resins is also described in the prior art. For the method according to the invention, in particular urea-formaldehyde resins and urea-melamine-formaldehyde resins are preferred, which are applied in common amounts. It is particularly advantageous to use resins which are low of formaldehyde, which show a low molar relation of formaldehyde to urea. The molar relation of formaldehyde to urea is advantageously between 0.8:1 to 1.05:1.

By treating the hackled wood with bisulfite however, also glues with a higher molar relationship of formaldehyde to urea as mentioned above may be applied. Also the wood material articles produced thereby show extremely low perforation values, which all satisfy the current regulations. With these resins—which are more reactive and cheaper compared to resins, which are low in formaldehyde—even boards of class E1 can be produced. The method according to the invention has the advantage, that common resins without additional formaldehyde binding agents can be used in the glue, without having any negative physical or mechanical effects to the end product. However, the applied glue may—if desired—contain additionally formaldehyde binding substances.

The glue may comprise in addition to the aminoplast resin further additives as for example curing agents to accelerate the curing or hardening, hydrophobic agents, inert salts, pH-conditioners, stabilizers, fungicides or biocides.

The gluing is achieved preferably by pressing the finally hackled wood, which is provided with the glue, at temperatures of 120° to 250° Celsius. Under these conditions, the aminoplast resin cures relatively fast and one achieves wood material articles with positive mechanical properties, which are for the most part insensitive against moisture.

Exemplary Embodiment:

Two fibre boards S1 and V1 were produced with the above described method by using a formaldehyde-urea resin, having a molar ratio of formaldehyde to urea of 1:1.08, with the only distinguishing feature, that for the manufacturing of the fibre board V1 the hackled wood was not treated with bisulfite before the impregnation process. The treatment of the hackled wood with bisulfite was done at a pressure of 8.5 bar with an amount of bisulfite of 3 kg per m³ of hackled wood and for a duration of 3.5 minutes. After the pre-treatment of the wood, the wetting with a none-impregnation agent and after that the pressing was done.

In table 1 the perforation values (according to DIN EN 120—wood materials—determination of formaldehyde content) of both fibre boards S1 and V1 are shown.

TABLE 1

| Fibre board | Perforation values in MCHO/100 g fibre board |
|---|---|
| S1 | 2.5 |
| V1 | 6.5 |

The values in table 1 show, that by treating the hackled wood with bisulfite wood material articles can be obtained, which show extremely low formaldehyde emissions. Further, the fibre board S1 emitted only extremely low amounts of other chemical compounds. Additionally, fibre board S1 was significantly brighter than fibre board V1.

1. A method for the production of a wood material article comprising: providing wood chips or wood fibres, treating said wood chips or wood fibres prior to a gluing process in saturated water vapour atmosphere or in saturated water vapour air for a duration of 3-8 minutes with bisulfite salt at a pressure of 6-12 bar, and gluing said wood chips or wood fibres together in a standard gluing process.

2. Method according to claim 1, wherein the wood chips or wood fibres are treated with the bisulfite salt in a cooker.

3. Method according to claim 1, wherein the wood chips or wood fibres are treated with the bisulfite salt in a refiner.

4. Method according to claim 1, wherein the bisulfite salt is added in an amount of 1 to 30 kg/m³ wood.

5. Method according to claim 1, wherein the bisulfite salt is chosen from the group consisting of sodium bisulfite and ammonium bisulfite.

6. Method according to claim 1, wherein the wood chips or fibres treated with bisulfite salt are glued together with an aminoplast resin.

7. Method according to claim 6, wherein the aminoplast resin is chosen from the group consisting of urea formaldehyde resin, melamin formaldehyde resin, urea-melamin formaldehyde resin and melamin urea phenol formaldehyde resin.

8. A wood material article, comprising wood chips or wood fibres glued together with an aminoplast resin, wherein the wood chips or fibres are, prior to the gluing process, treated with bisulfite salt in saturated water-vapour atmosphere or in saturated water-vapour air for a duration of 3 to 8 minutes at a pressure of 6 to 12 bar.

9. A method according to claim 4, characterized in that the bisulfite salt is added in an amount of 3 to 12 kg/m³ wood.
